(19) United States
(12) Patent Application Publication
(10) Pub. No.: US 2010/0332115 A1
(43) Pub. Date: Dec. 30, 2010

(54) METHOD AND APPARATUS FOR INTERACTIVE ROUTING AND SCHEDULING SYSTEM

(76) Inventor: Robert Erhardt, San Diego, CA (US)

Correspondence Address: DLA PIPER US LLP, 1999 AVENUE OF THE STARS, SUITE 400, LOS ANGELES, CA, 90067-6023, US

(21) Appl. No.: 12/712,697

(22) Filed: Feb. 25, 2010

Related U.S. Application Data
(60) Provisional application No. 61/155,879, filed on Feb. 26, 2009.

(51) Int. Cl. G01C 21/00

(52) U.S. Cl. 701/200

(57) ABSTRACT

The system provides a method and apparatus for scheduling and routing. The system provides a database of locations, paths, and estimated time limits for a plurality of locations at a destination. A visitor provides input as to desired locations as well as a time limit for the overall visit. The system also includes information about weather, total expected visitors, visitors who have selected certain locations, start time of visit, and other factors that may affect traffic flow and accessibility of locations by visitors. Using this data, the system provides a schedule and a route for the visitor designed to satisfy the visitors desire to visit certain locations within a certain time frame.

This patent application claims priority to U.S. Provisional Patent Application No. 61/155,879 filed on Feb. 26, 2009, which is incorporated by reference herein in its entirety.

### BACKGROUND OF THE SYSTEM

1. Field of the Invention

The invention relates to a method and apparatus for routing and scheduling.

2. Background of the Invention

There are a number of destinations that welcome large numbers of visitors to engage with a plurality of attractions, presentations, exhibits, and the like. Zoos, amusement parks, museums, malls, retail stores, and other such destinations are each environments that have a unique geography filled with possible locations to visit, peruse, or use. It is rare that any one visitor can systematically engage all possible locations in a realistic time period. Instead, a visitor may desire to visit only certain locations within the environment. In addition, a visitor may have a specific time limitation for the visit. This time limitation may be fixed due to the operating hours of the destination, or it may be personal, based on time available to the visitor. Regardless, the visitor is faced with a scheduling and routing problem when visiting a destination, namely how to maximize the likelihood of visiting all of the locations that are desired within the time limitation.

In some destinations, routing is free form, with many possible paths between locations. In a store or other retail environment, in a zoo, aquarium, or amusement park, there are grids or other layouts that make it possible to move in many directions at any one time and to have multiple paths between any two or more locations. In some destinations, such as a mall, the design may be such as to require most visitors to follow a single path with very few branching possibilities. Often a mall is designed to force a visitor arriving on a floor (such as via escalator, stairs, or ramp, to traverse at least half of that floor before encountering a way to another floor. This ensures that the visitor will be faced with a maximum of exposure to retail locations along the path. Even in those restricted environments, however, the visitor often has at least right/left and up/down decision points where some variation can occur. Like malls, gaming establishments such as casinos also have a restricted choice of paths to certain locations, to maximize exposure to gaming opportunities.

Regardless of the type of destination, a visitor still desires to be able to have a best chance to accomplish the visitors goals in a reasonable time frame. There have been some attempts to assist visitors in this regard. For example, many amusement parks provide for a reserved pass system for certain rides and attractions so that a visitor need not wait in line unnecessarily. This helps in scheduling but does not provide any assistance in routing.

### BRIEF SUMMARY OF THE SYSTEM

The system provides a method and apparatus for scheduling and routing. The system provides a database of locations, paths, and estimated time limits for a plurality of locations at a destination. A visitor provides input as to desired locations as well as a time limit for the overall visit. In one embodiment, the visitor may also rank the locations in an order of preference. In other embodiments, the visitor may classify locations in one or more categories or levels which may provide a weighting factor for use by the system. The system also includes information about weather, total expected visitors, visitors who have selected certain locations, start time of visit, and other factors that may affect traffic flow and accessibility of locations by visitors. Using this data, the system provides a schedule and a route for the visitor designed to satisfy the visitors desire to visit certain locations within a certain time frame.

In one embodiment, the system has a plurality of options for routing the visitor from a first point to a second point. Which path is used may be dependent on a number of factors, including factors selected by the visitor, historical factors related to the destination and/or visitor, to destination capacity, time of day, or other factors. For example, if a particular path is expected to be crowded due to the number of visitors on that route, the system may automatically re-route a visitor to a different path that is less congested.

### BRIEF DESCRIPTION OF THE DRAWINGS

FIG. 1 is a flow diagram of the operation of an embodiment of the system.

FIG. 2 is a flow diagram of the log-in process of an embodiment of the system.

FIG. 3 is a flow diagram of the visit length entry portion of an embodiment of the system.

FIG. 4 is a flow diagram of the generation of a pre-packaged route/schedule in an embodiment of the system.

FIG. 5 is a flow diagram of the exhibit selection process in an embodiment of the system.

FIG. 6 is a flow diagram of the operation of routing and scheduling in an embodiment of the system.

FIG. 7 is an example of destinations and legs in an embodiment of the system.

FIG. 8 is a flow diagram of the operation of the route/schedule step of FIG. 6 in an embodiment of the system.

FIG. 9 is a flow diagram of the leg selection process in an embodiment of the system.

FIG. 10 is an example of a computer system for implementing an embodiment of the system.

FIG. 11 is an example hardware embodiment of the system.

### DETAILED DESCRIPTION OF THE SYSTEM

The present system provides a method and apparatus for scheduling and routing visitors at a destination having a plurality of locations that can be visited. In the following description, the system is described in connection with an embodiment that routes and schedules visitors to a zoo. However, the system is not limited to this embodiment and has application to any situation where scheduling and routing are desired.

### Zoo Example

Zoos, such as the San Diego Zoo, are popular destinations. For example, the San Diego Zoo has over 200 active exhibits and over 100 acres of space. Over 3 million people visit the zoo each year. Some of the most popular exhibits have long waits or lines to experience the exhibit. Depending on the season, some exhibits are closed or limited. Statistics have shown that many visitors spend as much as 30 to 40 percent of their time just trying to navigate from one location to the next. All visitors would prefer to see the exhibits that they want to see in the time available to the visitors.

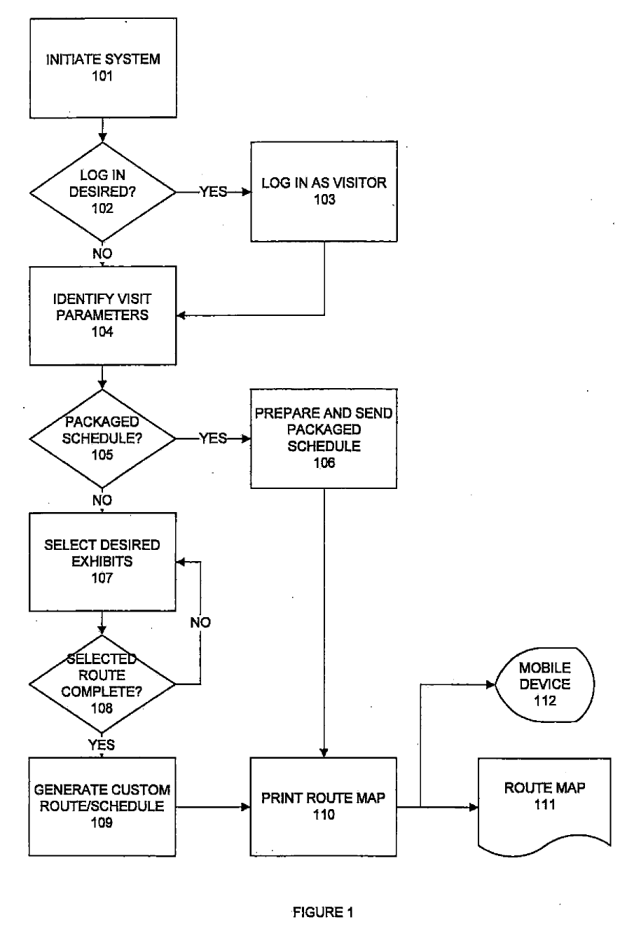

The system provides a way for visitors to generate a custom route and schedule for exhibits that the visitor wishes to see. FIG. 1 is a flow diagram illustrating the operation of an embodiment of the system. At step 101 a visitor initiates the system. In one embodiment the system is accessed via a web browser by going to a hosting web site. For example, for the zoo example, the visitor would go to the zoo's website and access the routing and scheduling system.

At step 102 the visitor can choose to log in to the system. In some cases, the visitor may be a new visitor and in other cases may be a returning visitor. After log-in (if selected), at step 103, the visitor provides start time/end time information. This information includes the date or dates of the expected visit, and the approximate time the visitor will be arriving and leaving the zoo. This information is important because some routing and scheduling is seasonal in nature and/or is affected by time of day or day of week.

At block 104 the visitor can provide other parameters about the visit. This information may include preferred exhibits, type of movement (e.g. wheelchair, limited mobility, accompanying children, and the like), preferred snack/meal/rest periods, and other information that may be useful in generating the schedule and routing. At decision block 105 the visitor is presented with the opportunity to get a packaged route/schedule from the system. In cases of a first time visitor or a user whose preferences/history are entered into the system, a system prepared route/schedule may be acceptable to the visitor. If so, at step 106, the system generates and forwards the pre-packaged schedule to the user. The visitor may then print the schedule on a local printer (step 111) and/or enter it into a cell phone or PDA (step 112) for interactive use at the zoo.

If the visitor wishes to generate a custom schedule, the system proceeds to step 107 where the visitor is presented with an interactive map representing the zoo. The visitor then clicks and selects desired exhibits and other facilities like restaurants and shops, etc. which the system instantly translates into a “least cost route” based upon input parameters. In this interactive map the visitor is also presented with information options about the exhibits that may be still images with text or full motion video.

At step 108, when the visitor is satisfied with their selections, they will select a printer icon to generate a grid view of the suggested route with timings and individual exhibit information.

At step 109 the system uses the information from the visitor and generates a route/schedule designed to optimize the visit. The route/schedule attempts to ensure that the preferred exhibits can be seen by the visitor in the time allotted.

At step 110 the system the system formats the compiled route for printing and/or display. This formatting will take into consideration the desired stops and will present them in “least cost” route sequence. The route will be formatted grid style to facilitate ease of use and sequence of steps in the route. The grid formatting may also contain graphical representations of turn-by-turn steps through the route or graphical images of stops or key route milestones.

At step 111 the system prints and the grid view of the suggested route, which the visitor will then bring with them to conduct their visit. This grid view would also have the ability to be displayed at step 112 on any number of portable devices like cellular phones or laptop or tablet computing devices. In one embodiment, the system can be accessed via a cell phone, PDA, or other portable or mobile computing platform. The grid that is generated has the flexibility to display not only routing information, but information about the route stops and the other exhibits or attractions along the way. In one embodiment the system the exhibit information supplied in the grid may be customized based on inputs supplied in step 104. One example would be that the information simplified for presentation to children, if that information was supplied at step 104.

Log-In

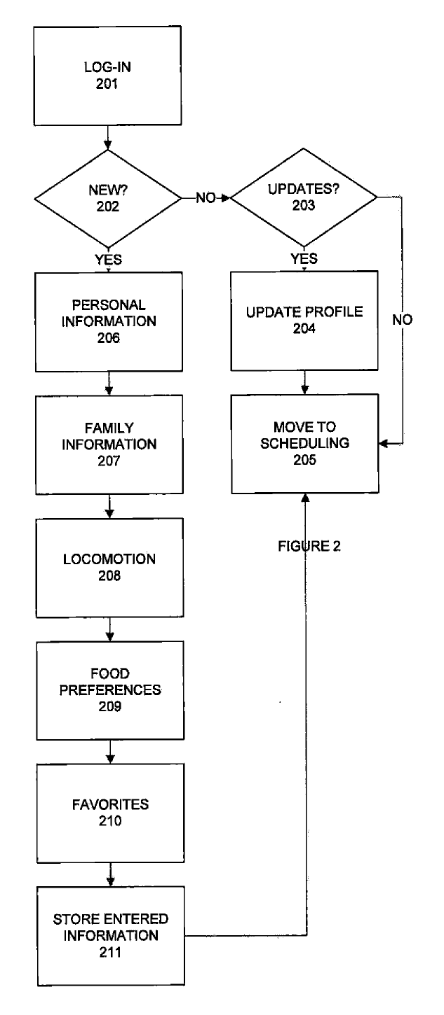

FIG. 2 is a flow diagram of the log-in process of an embodiment of the system. This corresponds to the activity at step 102 of FIG. 1. At step 201 a visitor logs in to the system. At step 202 it is determined if the user is a new user or a returning visitor, based upon an entered user ID and password. If returning, the system proceeds to step 203 and asks the visitor if there are any updates to be made to the visitor profile. If so, the system provides the visitors profile to the visitor at step 204. There the visitor can update the various parameters and preferences related to the visitors account. After step 204, or if there are no updates at step 203, the system advances to the scheduling function at step 205.

If the visitor is a new visitor at decision block 202, then a new account must be generated. At step 206 the system requests personal information form the user. In one embodiment of the system, this might includes age, birth date, address, user name, password, e-mail address, and other personal information to allow the creation of a unique account for the visitor. At optional step 207 the system requests family information. This information includes the spouse, number of children and their ages, and other information that may be related to a group visit to the destination. It is helpful to have the ages of the children because that can affect the routing and scheduling function that will be generated for a particular family or group of visitors. Although optional step 207 is presented as providing family information, it could also be used to gather group information if there is to be a group visit to the destination. All of the information provided at this step will be used to tailor the information displayed to match the intended audience, weather that be for children, parents, or other constituency. The system also tracks the ages of the user and family members so it can make future adjustments to mobility considerations that may be age based, such as need for strollers, wheelchairs, walking speed limitations, and the like.

At step 208 questions about locomotion and mobility are presented. The system generates routes and schedules based on the movement of the visitor from place to place. If the visitor or someone in the visiting party is limited in movement in some way, the system can take that into account in both the timing and the routing of the visit. For example, if a visitor is in a wheelchair, certain routes may be foreclosed to the visitor. In addition, the time to traverse a particular route may be slower for someone using a cane or chair. The age of the visitors can also have an impact. Infants and toddlers in strollers travel more slowly and there may be a need to route the visitors near changing stations. Even if walking without a stroller, young children are often slower than teens or adults. The system can adjust the timing of routes based on the expected slowest member of a group of visitors.

At step 209 the system requests information about eating preferences. For example, if there are food restrictions, the system may avoid routing a visitor or a group near a particular eating location during expected snack or lunch times. In addition, a visitor may prefer stand-up or quick snacking instead of a sit down meal. The system can take these preferences into account during a routing and scheduling operation.

At step 210 the visitor can enter favourites related to the destination. For a zoo, the visitor can indicate favourite animals, species, continents, or other choices. The visitor may prefer, when possible, to view exhibits during feeding times. All of this information can be associated with the profile of a visitor and stored in a database for use in the scheduling and routing of the visitor.

At step 211, the information that was entered in various screens and places in the system will be stored to a master database for later retrieval and use for return visits to the system by the individual visitor. The system then proceeds to step 205 to begin the scheduling process.

Timing of Visit

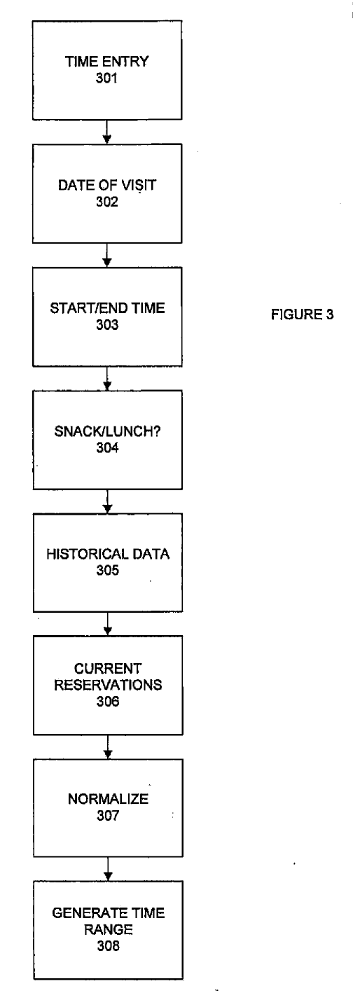

FIG. 3 is a flow diagram of the visit length entry portion of an embodiment of the system corresponding to step 103 of FIG. 1. At step 301 the visitor is presented with visit time entry options. At step 302 the visitor indicates the date of the visit. At step 303 the visitor indicates the expected start and end time of the visit. At 304 the visitor may indicate the preferred times, if any, for snacks and lunch, or other meals and breaks.

At step 305 the system retrieves historical data about the destination that may be relevant to the timing of the visit. For example, certain seasons, days of the week, or even times of day may have unique traffic patterns and congestion conditions that should be taken into account during a routing and scheduling operation. At step 306 the system also looks at the current reservation status, if any, for the particular visit date, along with routes and schedules that have already been generated for that date and time.

At step 307 the system can use the historical and reservation information to normalize the length of time of the visitor. For example, a six hour visit at a busy time may be equivalent to a five hour visit during normal operation. On the other hand, it may be equivalent to a seven hour visit during extremely light periods.

Using the information, the system generates a time range representing the effective length of the visit. This range may be used in subsequent operations to aid in generating the route and schedule of the visitor. In another embodiment, there is no normalizing at this point, but congestion, historical, and other conditions may be considered in determining travel rate and length of time at each exhibit in dynamically generating a route and schedule.

Pre-Packaged Schedule

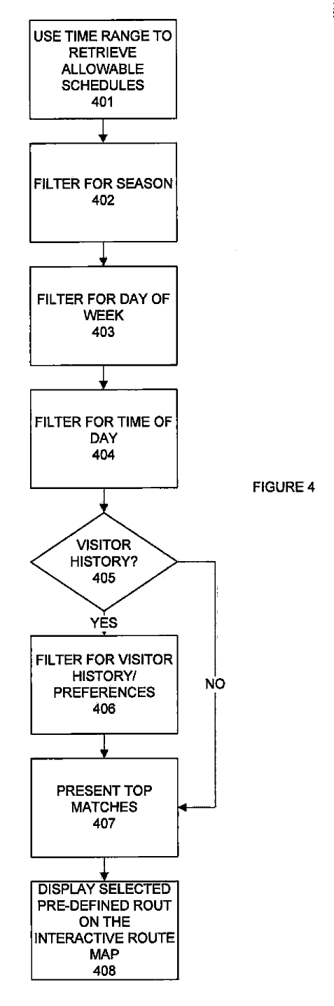

FIG. 4 is a flow diagram of the generation of a pre-packaged route/schedule in an embodiment of the system, implementing step 105 of FIG. 1. Some visitors may prefer to take advantage of pre-packaged routes and schedules instead of generating their own custom schedule. At step 401, the system uses the time range of the visit to retrieve allowable schedules. The pre-packaged schedules are in a searchable database and are characterized by a plurality of parameters and metrics. One of the metrics is time, namely the expected time need to complete the schedule. At step 401, only those schedules that are less than or equal to the length of the expected visit are available for presentation to the visitor.

At step 402 the eligible schedules are filtered based on the season. Some attractions and exhibits may not be available or may be less desirable during certain seasons. Those schedules that may be seasonably sensitive are removed from the list of candidates. At step 403, the list is further culled based on day of the week. The amount of visitor traffic may vary depending on the day of the week or weekend. Those schedules that are more optimal for the particular day of the week are kept in the list of possibilities.

At step 404 the list is further reduced based on the time of day. Some exhibits may be morning or afternoon based, and if the visit is principally to take place in that time period, it would be desirable to present the optimal candidates.

Step 405 determines if there is a visitor profile available for the visitor requesting the pre-packaged schedule. If so, the preferences, locomotion data, and other profile parameters can be used to further delimit the possible choices of schedules. This filtering is performed at step 406.

After step 406, or if there is no visitor history available at step 405, the system presents the top matches to the visitor at step 407. These matches include the exhibits included, the approximate length of time, and other information that the visitor can use in order to select on of the offered packages. In step 408 the system responds to the users selection of a pre-packaged schedule by displaying the selected route on the interactive route map.

Exhibit Selection

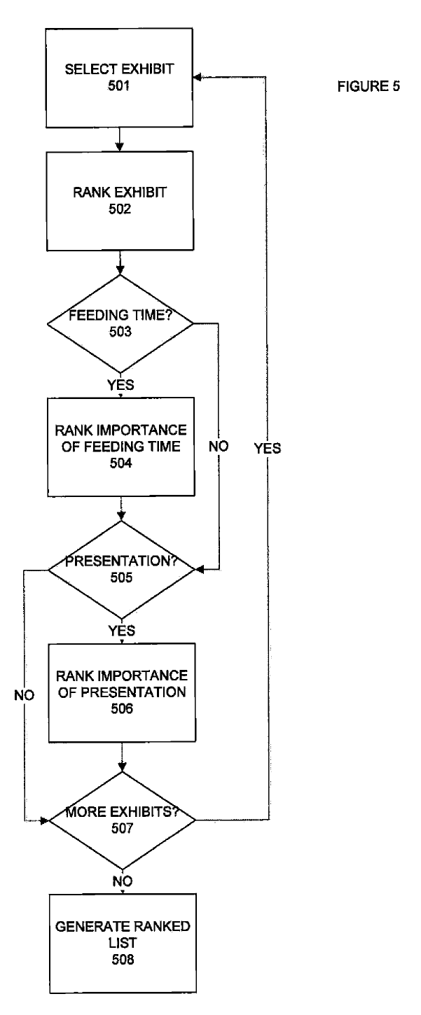

FIG. 5 is a flow diagram of the exhibit selection process in an embodiment of the system, corresponding to step 106 of FIG. 1. At step 501 the visitor is presented with a list or menu of the available exhibits. This list may be pre-filtered based on the season, day, and time of the visit. The visitor selects an exhibit at step 501. At step 502, the visitor may be asked to rank or characterize the exhibit's importance to the visitor. This may be via a pull down menu that offers several choices (e.g. very important, somewhat important, “must see”, and the like) or some means to indicate the preference of the visitor in making sure a particular exhibit is included in the schedule.

At optional step 503, the system may ask if the visitor wants to see the exhibit during a particular time, such as the example given of feeding time. If so, the system again asks the visitor to rank or indicate preference on this parameter at step 504.

At some exhibits, there may periodically be a formal presentation given by a curator or exhibit expert. The visitor is asked to indicate if they are interested in visiting the exhibit during such a presentation at step 505. If so, the visitor is asked to rank the importance of visiting during this time at step 506.

At step 507 the visitor is asked if they would like to add more exhibits to their list. If so, the system returns to step 501. If not, the system generates a list of the users exhibits at step 508. This list is associated with preference information so that intelligent routing and scheduling can be performed.

Routing/Scheduling

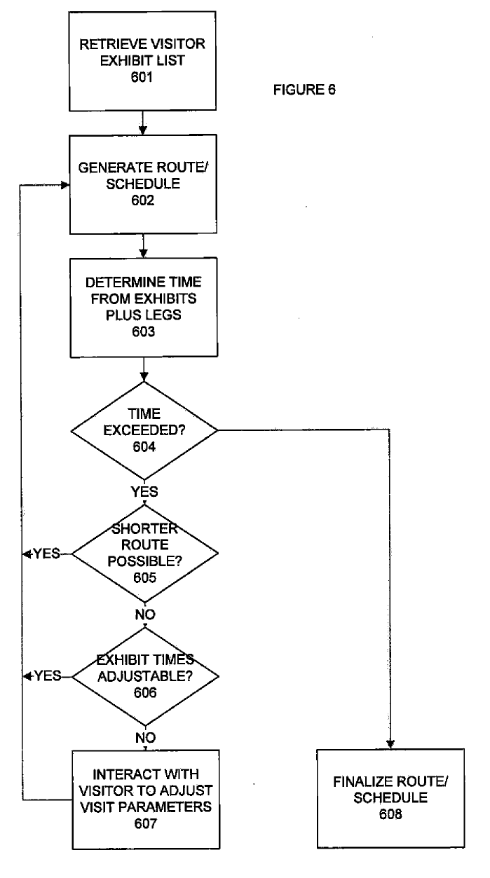

FIG. 6 is a flow diagram of the operation of routing and scheduling in an embodiment of the system implementing step 107 of FIG. 1. At step 601 the system retrieves the exhibit list generated at step 106 (and in the steps of FIG. 6), or generated by any other suitable means. At step 602 the system generates a possible route and schedule that includes all of the exhibits selected by the visitor and, as much as possible, satisfies feeding time and presentation preference indications. The routing, described in more detail below, attempts to take into account the locomotion requirements, eating preferences, and other profile preferences of the visitor or visiting group.

At step 603 the system determines the total expected time of the generated possible schedule by combining the travel time of each leg of the route between exhibits, as well as the expected viewing time at each exhibit. The system can use historical data to estimate how long each visitor tends to stay at a particular exhibit. At decision block 604 it is determined if the possible schedule exceeds the time available to the visitor. If not, the route and schedule is finalized at step 608 for presentation to the visitor.

If the proposed schedule is too long at block 604, the system checks to see if a shorter route is possible at step 605. There are often many legs between exhibits and the first proposed schedule will not necessarily optimize for travel time, depending on other factors. If it is possible to select shorter routes at step 605, the system does so and returns to step 602. If no shorter routes are possible, then the system next determines if the exhibit times are adjustable. For example, attempting to route a visitor to an exhibit to see a presentation or feeding time may result in the visitor getting to the exhibit early and spending more time at the exhibit than is typical. This can add to the overall time of the schedule in a way that could make it longer than the available visitor time.

If exhibit times are adjustable at step 605, the system makes the adjustment and returns to step 602 to generate another possible schedule and route. If the exhibit times are not adjustable at step 605, the system enters an interactive mode with the visitor at step 607 to inform the visitor of timing conflicts. The system can then ask the visitor to reduce the exhibits, extend the visiting time, compromise on feeding/presentation preferences, or other adjustments so that the visitor can obtain an acceptable route and schedule. After this interactive mode, the system returns to step 602 to generate another possible schedule. The system is fast enough that the visitor can adjust one parameter at a time to see what impact it will have on the schedule.

Exhibits and Legs

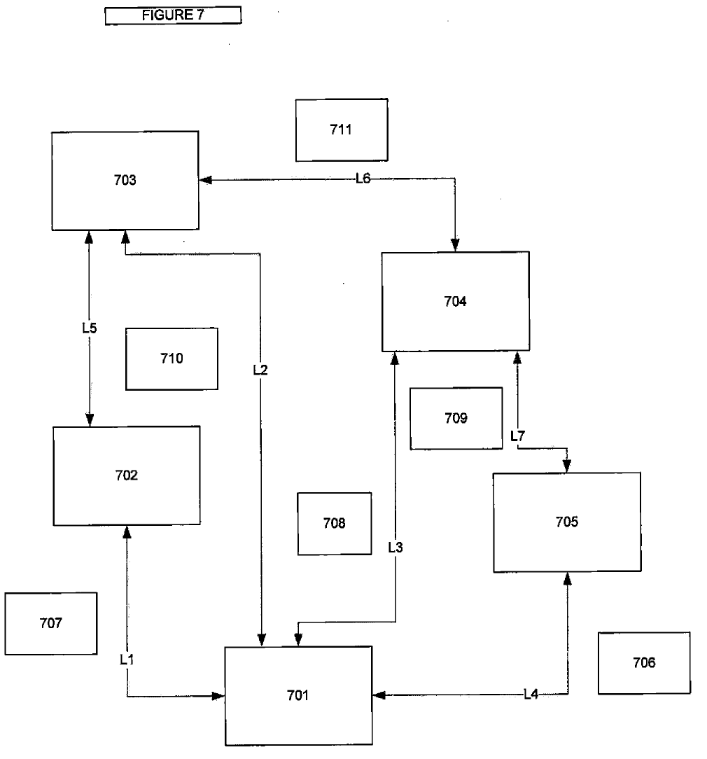

FIG. 7 is an example of destinations and legs in an embodiment of the system. The example shows a destination with a plurality of locations/exhibits 701-711. In the example shown, the larger exhibits 701-705 are examples of exhibits selected by a visitor. Exhibits 706-711 are exhibits not selected by the visitor. Legs are the travel routes between exhibits and are represented by legs L1-L7. There are typically multiple paths from one exhibit to the next and the routing and scheduling can take many forms. In some cases, the system may desire to route a visitor past certain unselected exhibits, depending on certain policy, marketing, traffic balance, or other considerations.

Each leg has an associated travel time that is a function of the time of day, day of week, season, historical number of visitors, confirmed reservations, and the like, as well as the locomotion parameters of the visitor under consideration. Fore example, leg L1 may be a five minute walk for an able bodied adult during peak hours, or a 10 minute journey for a family with strollers during light hours. In implementing the system, the possible legs between exhibits are mapped and characterized as a function of time in one embodiment. This is distinguished from characterizing them as a function of distance, because time is a more useful measure for our purposes. In addition, distance doesn't indicate whether a leg is uphill, via stairs, along an escalator, etc.

Route/Schedule

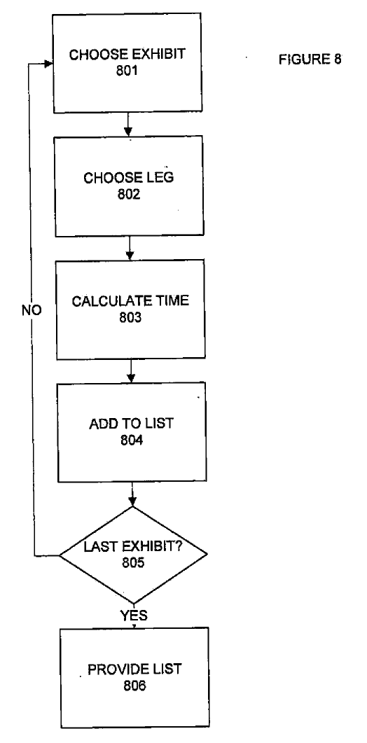

FIG. 8 is a flow diagram of the operation of the route/schedule generation step 602 of FIG. 6 in an embodiment of the system. At step 801 the system chooses an exhibit from the list provided by the visitor. At step 802 the system chooses a leg from that exhibit to the next exhibit. At step 803 the system calculates the time of the exhibit and the leg and adds the link to a list at step 804. As noted above, the selection of the leg is typically one of a plurality of possible legs and is chosen based on factors described below. In one embodiment, time constrained exhibits may be selected first even though they may be in the middle of a route. If feeding time is important, the system may start with an exhibit whose feeding time falls within the start time and end time as indicated by the visitor. The system then works backward and forward from that point to establish the best route for the visitor to satisfy the parameters selected by the visitor.

At step 805 it is determined if there are any more exhibits to route. If so, the system returns to step 801 and chooses the next exhibit from the visitor list. If not, the system moves to step 806 and provides the generated list of exhibits and legs to the system.

### Leg Selection

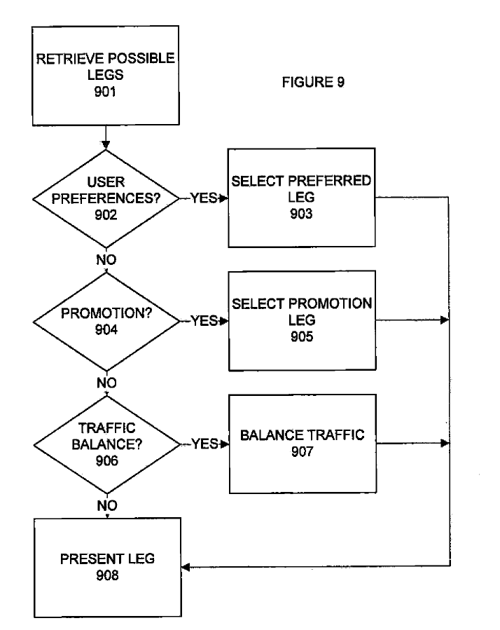

FIG. 9 is a flow diagram of the leg selection process of step 802 of FIG. 8 in an embodiment of the system. At step 901 the system examines possible legs from a current exhibit to one or more next exhibits. At step 902 the system checks to see if one of the legs optimizes user preferences. For example, if the visitor has indicated penguins as a favourite animal, but has not selected the penguin exhibit for this visit, the system may want to route the visitor past the penguin exhibit if possible. If so, the system selects that leg at step 903.

If there are no visitor preferences that apply, the system checks to see if there are any promotions that are tied into the system at step 904. For example, a zoo may want to promote a particular exhibit that may not be selected by the visitor. If so, and if there is a leg that goes past the promoted exhibit, the system selects that leg at step 905.

If there is no promotion, the system then checks to see if a particular selection of a leg will help promote traffic balance at step 906. Based on the expected traffic patterns and other route/schedules that have been generated, the system may select a leg that will promote smooth traffic flow at step 907. After a leg has been selected based on one of the criteria, the system presents the leg to the next steps of the process at step 908.

Visitor Tracking/History

The system contemplates incorporating a way to track a visitor during their visit. This may be accomplished in a number of ways. For example, a visitor arriving at the park is provided with some way to track the visitor. This may be via a GPS device that the visitor carries that passively maps the visitor during the visit and is collected at the end of the visit. In another system, the visitor is given an RFID device that is read by readers stationed near exhibits and along legs. In another embodiment, the visitor is provided with a unique ID, such as on the visitor's generated route/schedule. The visitor is prompted to key in the ID at each exhibit visited. Whichever scheme is chosen, historical data is generated for each visitor to the destination, helping to measure effectiveness of the system, travel times on legs, typical viewing times at exhibits, and other data that can be used in future routing/scheduling to optimize the system.

In another embodiment, when the visitor checks in, the system may provide texts or voicemails or other alerts to the visitors mobile phone or PDA to remind them of approximately where the visitor should be at different times during their scheduled visit. This can help the visitor maximize the visit and takes the responsibility for tracking time away from the visitor and onto the system.

Route/Schedule Storage/Sharing

One advantage of the system is that routes and schedules can be stored by the visitor on the system and retrieved when the visitor logs in. Because the route/schedule is digitally stored, the schedule can be shared with other visitors via email or other means. This allows a visitor who believes that they have an optimal route/schedule to share it with friends or others. The storage mechanism also enables the visitor to review past visits using the stored data. In one embodiment, the system maintains webcams at the exhibits and allows the visitor to recreate their visit virtually by moving from web cam to web cam using the same routing that was part of a previous visit.

In another embodiment of the system, the system can automatically generate coordinated supplementary information about the route that can be accessed by the visitor on a cell phone, PDA, or other mobile computing device. In addition, the system may generate an audio and/or video podcast that can be accessed by the user at each of the exhibits to more fully enjoy the exhibit. For example, when the route is prepared and finalized, pre-recorded audio and/or multimedia files can be assembled in the order of exhibits to be visited by the visitor. The files are made available for download by the user to a content player of the visitor's choice. Each file can be preceded and followed by start/stop commands so that the visitor knows when to access the content. In other instances, the visitor can be presented with a plurality of content files, each with their own title identifying them as being associated with a particular exhibit, so that the visitor can simply access the correct file when travelling the route.

Example System

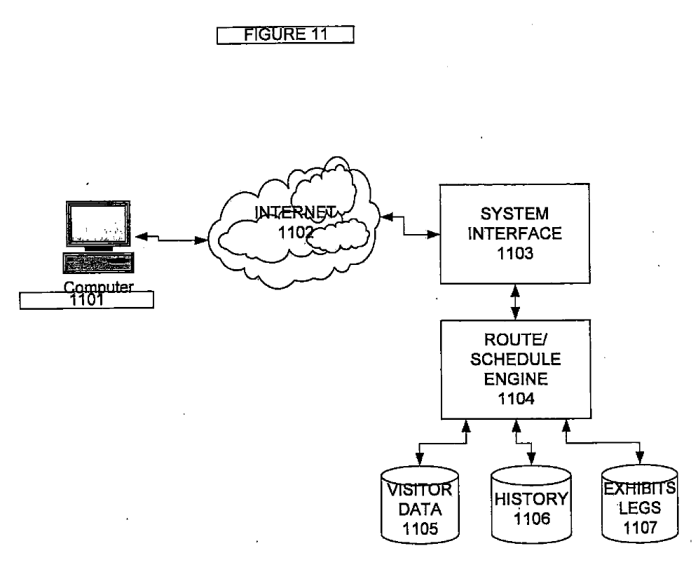

FIG. 11 is an example hardware embodiment of the system. A visitor uses their own computer 1101 to access the system via Internet 1102. A system interface 1103 is used to handle communications between the visitor and the system. The interface 1103 is coupled to a route/schedule engine 1104 that is used to handle the generation of the route and schedule for a particular visit. The route/schedule engine 1104 is coupled to one or more databases such as visitor data 1105, history data 1106, and exhibits and leg storage 1107. The engine 1104 retrieves data as appropriate to generate the route and schedule for a particular visitor.

### Embodiment of Computer Execution Environment (Hardware)

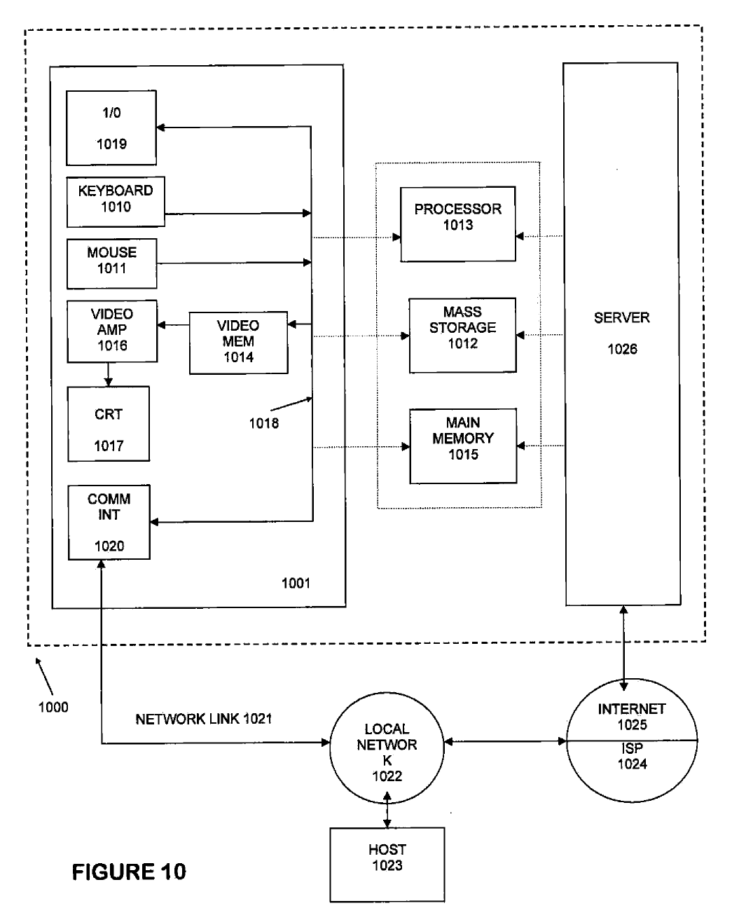

An embodiment of the system can be implemented as computer software in the form of computer readable program code executed in a general purpose computing environment such as environment 1000 illustrated in FIG. 10, or in the form of bytecodes running on a processor (or devices enabled to process bytecodes) existing in a distributed environment (e.g., one or more processors on a network). A keyboard 1010 and mouse 1011 are coupled to a system bus 1018. The keyboard and mouse are for introducing user input to the computer system and communicating that user input to central processing unit (CPU 1013. Other suitable input devices may be used in addition to, or in place of, the mouse 1011 and keyboard 1010. I/O (input/output) unit 1019 coupled to bi-directional system bus 1018 represents such I/O elements as a printer, A/V (audio/video) I/O, etc.

Computer 1001 may include a communication interface 1020 coupled to bus 1018. Communication interface 1020 provides a two-way data communication coupling via a network link 1021 to a local network 1022. For example, if communication interface 1020 is an integrated services digital network (ISDN) card or a modem, communication interface 1020 provides a data communication connection to the corresponding type of telephone line, which comprises part of network link 1021. If communication interface 1020 is a local area network (LAN) card, communication interface 1020 provides a data communication connection via network link 1021 to a compatible LAN. Wireless links are also possible. In any such implementation, communication interface 1020 sends and receives electrical, electromagnetic or optical signals which carry digital data streams representing various types of information.

Network link 1021 typically provides data communication through one or more networks to other data devices. For example, network link 1021 may provide a connection through local network 1022 to local server computer 1023 or to data equipment operated by ISP 1024. ISP 1024 in turn provides data communication services through the world wide packet data communication network now commonly referred to as the “Internet” 1025. Local network 1022 and Internet 1025 both use electrical, electromagnetic or optical signals which carry digital data streams. The signals through the various networks and the signals on network link 1021 and through communication interface 1020, which carry the digital data to and from computer 1000, are exemplary forms of carrier waves transporting the information.

Processor 1013 may reside wholly on client computer 1001 or wholly on server 1026 or processor 1013 may have its computational power distributed between computer 1001 and server 1026. Server 1026 symbolically is represented in FIG. 10 as one unit, but server 1026 can also be distributed between multiple “tiers”. In one embodiment, server 1026 comprises a middle and back tier where application logic executes in the middle tier and persistent data is obtained in the back tier. In the case where processor 1013 resides wholly on server 1026, the results of the computations performed by processor 1013 are transmitted to computer 1001 via Internet 1025, Internet Service Provider (ISP) 1024, local network 1022 and communication interface 1020. In this way, computer 1001 is able to display the results of the computation to a user in the form of output.

Computer 1001 includes a video memory 1014, main memory 1015 and mass storage 1012, all coupled to bi-directional system bus 1018 along with keyboard 1010, mouse 1.011 and processor 1013.

As with processor 1013, in various computing environments, main memory 1015 and mass storage 1012, can reside wholly on server 1026 or computer 1001, or they may be distributed between the two. Examples of systems where processor 1013, main memory 1015, and mass storage 1012 are distributed between computer 1001 and server 1026 include Internet based personal digital assistants, Internet ready cellular phones and other Internet computing devices, and in platform independent computing environments.

The mass storage 1012 may include both fixed and removable media, such as magnetic, optical or magnetic optical storage systems or any other available mass storage technology. Bus 1018 may contain, for example, thirty-two address lines for addressing video memory 1014 or main memory 1015. The system bus 1018 also includes, for example, a 32-bit data bus for transferring data between and among the components, such as processor 1013, main memory 1015, video memory 1014 and mass storage 1012. Alternatively, multiplex data/address lines may be used instead of separate data and address lines.

In one embodiment of the invention, the processor 1013 is a microprocessor such as manufactured by Intel, AMD, Sun, etc. However, any other suitable microprocessor or microcomputer may be utilized. Main memory 1015 is comprised of dynamic random access memory (DRAM). Video memory 1014 is a dual-ported video random access memory. One port of the video memory 1014 is coupled to video amplifier 1016. The video amplifier 1016 is used to drive the cathode ray tube (CRT) raster monitor 1017. Video amplifier 1016 is well known in the art and may be implemented by any suitable apparatus. This circuitry converts pixel data stored in video memory 1014 to a raster signal suitable for use by monitor 1017. Monitor 1017 is a type of monitor suitable for displaying graphic images.

Computer 1001 can send messages and receive data, including program code, through the network(s), network link 1021, and communication interface 1020. In the Internet example, remote server computer 1026 might transmit a requested code for an application program through Internet 1025, ISP 1024, local network 1022 and communication interface 1020. The received code maybe executed by processor 1013 as it is received, and/or stored in mass storage 1012, or other non-volatile storage for later execution. In this manner; computer 1000 may obtain application code in the form of a carrier wave. Alternatively, remote server computer 1026 may execute applications using processor 1013, and utilize mass storage 1012, and/or video memory 1015. The results of the execution at server 1026 are then transmitted through Internet 1025, ISP 1024, local network 1022 and communication interface 1020. In this example, computer 1001 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for implementing a method and apparatus for routing and scheduling has been described.

What is claimed is:

1. A method for routing and scheduling comprising:
selecting one or more exhibits from a plurality of available exhibits;
establishing a time period in which to visit the selected exhibits;
defining one or more legs between the selected exhibits;
assigning a travel time value to each leg;
assigning a viewing time value to each selected exhibit;
selecting an order of the selected exhibits and appropriate legs so that the total travel time and viewing time is less than or equal to the time period.

2. The method of claim 1 wherein the time period comprises a starting time and an ending time selected by a visitor.

3. The method of claim 1 wherein the step of assigning a travel time to each leg comprises determining a locomotion value of a visitor.

4. The method of claim 1 wherein selecting an order of the selected exhibits is based on a profile of preferences of a visitor.

5. The method of claim 1 further including generating a map of a selected schedule and route and providing it to a visitor.

6. The method of claim 1 further including generating a map of a selected schedule and route and electronically delivering it to a mobile device of a visitor.

7. The method of claim 1 further including generating multimedia content associated with the one or more selected exhibits.

8. The method of claim 7 further including providing the multimedia content to the visitor.
